(19) United States
(12) Patent Application Publication
(10) Pub. No.: US 2026/0291873 A1
(43) Pub. Date: Sep. 24, 2026

(54) Circuit and Method for Service Activation Testing (SAT)

(71) Applicant: Marvell Asia Pte Ltd, Singapore (SG)

(72) Inventors: Yaakov Yehezkel, Rehovot (IL); Amit Freedman, Yehud-Monosson (IL)

(21) Appl. No.: 19/459,784

(22) Filed: Jan. 26, 2026

Related U.S. Application Data
(60) Provisional application No. 63/751,195, filed on Jan. 29, 2025.

(51) Int. Cl. H04L 47/24; H04L 43/087; H04L 43/0888

(52) U.S. Cl. CPC H04L 47/24; H04L 43/087; H04L 43/0888

(57) ABSTRACT

A circuit and corresponding method inject, based on a configurable rate, generator traffic into a channel for service activation testing (SAT). The circuit comprises a frame generator that injects, based on the configurable rate, the generator traffic into the channel for the SAT. The channel incorporates incoming traffic on the channel and the generator traffic injected. The channel is associated with a target rate. The frame generator includes a controller. The circuit further comprises a data-rate sniffer to monitor the channel and generate feedback affected by the incoming traffic and the generator traffic injected. The controller controls the configurable rate for the SAT, dynamically, based on the feedback generated by the data-rate sniffer and the target rate. The circuit and corresponding method add a dynamic real-time ability which facilitates more accurate and versatile measurements for the SAT.

### RELATED APPLICATION

This application claims the benefit of U.S. Provisional Application No. 63/751,195, filed on Jan. 29, 2025. The entire teachings of the above application are incorporated herein by reference.

### BACKGROUND

Service Activation Testing (SAT) is a standardized methodology used to verify and validate performance of Ethernet services before they are handed over (deployed) to customers, or at an operational mode-before starting real traffic (frames, data), namely actual user traffic versus test (artificial) traffic. SAT ensures that the services meet predefined Service Level Agreements (SLAs) by testing performance indicators, such as throughput, latency, jitter, and frame loss, for non-limiting examples.

### SUMMARY

According to an example embodiment, a circuit comprises a frame generator configured to inject, based on a configurable rate, generator traffic into a channel for service activation testing (SAT). The channel incorporates incoming traffic on the channel and the generator traffic injected. The channel is associated with a target rate. The frame generator includes a controller. The circuit further comprises a data-rate sniffer configured to monitor the channel and generate feedback affected by the incoming traffic and the generator traffic injected. The controller is configured to control the configurable rate for the SAT, dynamically, based on the feedback generated by the data-rate sniffer and the target rate.

The controller may be further configured to: control the configurable rate for the SAT, dynamically, by configuring a token bucket, dynamically, to cause the frame generator to produce the generator traffic to supplement an actual line rate of the incoming traffic to achieve the target rate.

The data-rate sniffer may be further configured to output at least one status indicator configured to indicate a result of a comparison between an actual amount of generator traffic injected relative to an intended amount of generator traffic to be injected.

The channel may be a time-division multiplexing (TDM) channel. The data-rate sniffer may be configured to monitor: a data rate of the incoming traffic on the channel, a data rate of the generator traffic injected, and an overall total TDM data rate for the channel.

The data-rate sniffer may be further configured to output status indications for current and ongoing average rates of the data rate of the incoming traffic on the channel, the data rate of the generator traffic injected, and the overall total TDM data rate for the channel.

The data-rate sniffer may be further configured to monitor the data rate of the incoming traffic on the channel, the data rate of the generator traffic injected, and the overall total TDM data rate for the channel based on a total number of clock cycles to count between sniffer analysis events. A value for the total number may be based on a power of two and a configured value for a token increment of a token counter of a token bucket of the frame generator.

The incoming traffic on the channel may have strict priority over the generator traffic injected. The circuit may further comprise an output buffer. The output buffer may have a size of at least a maximum transmission unit (MTU) size.

The incoming traffic on the channel may have strict priority over the generator traffic injected and the generator traffic injected may be limited to single-word frames.

The data-rate sniffer may be further configured to generate at least one sniffer statistic for the SAT and output the at least one sniffer statistic generated.

The at least one sniffer statistic may represent at least one performance indicator, and the performance indicator may represent throughput, latency, jitter, frame loss, or a combination thereof for non-limiting examples.

According to another example embodiment, a method comprises injecting, based on a configurable rate, generator traffic into a channel for SAT. The channel incorporates incoming traffic on the channel and the generator traffic injected. The channel is associated with a target rate. The method further comprises generating feedback by monitoring the channel. The feedback generated is affected by the incoming traffic and the generator traffic injected. The method further comprises controlling the configurable rate for the SAT, dynamically, based on the feedback generated and the target rate.

Further alternative method embodiments parallel those described above in connection with the example circuit embodiment.

According to another example embodiment, an apparatus comprises means for injecting, based on a configurable rate, generator traffic into a channel for SAT. The channel incorporates incoming traffic on the channel and the generator traffic injected. The channel is associated with a target rate. The apparatus further comprises means for generating feedback by monitoring the channel. The feedback generated is affected by the incoming traffic and the generator traffic injected. The apparatus further comprises means for controlling the configurable rate for the SAT, dynamically, based on the feedback generated and the target rate.

Further alternative apparatus embodiments parallel those described above in connection with the example circuit embodiment.

According to another example embodiment, a system comprises a network interface and a device. The device includes a frame generator configured to inject, based on a configurable rate, generator traffic into a channel for SAT. The channel incorporates incoming traffic on the channel and the generator traffic injected. The channel is associated with a target rate. The frame generator includes a controller. The device further includes a data-rate sniffer configured to monitor the channel and generate feedback affected by the incoming traffic and the generator traffic injected. The controller is configured to control the configurable rate for the SAT, dynamically, based on the feedback generated by the data-rate sniffer and the target rate.

The system may be a server of at least one server of a data center and the device may be a system-on-chip (SoC).

Further alternative system embodiments parallel those described above in connection with the example circuit embodiment.

According to another example embodiment, a hardware description language (HDL) design structure is encoded on a machine-readable data storage medium. The HDL design structure comprises elements that when processed in a computer-aided design system generate a machine-executable representation of a device. The HDL design structure comprises a frame generator configured to inject, based on a configurable rate, generator traffic into a channel for SAT. The channel incorporates incoming traffic on the channel and the generator traffic injected. The channel is associated with a target rate. The frame generator includes a controller. The HDL design structure further comprises a data-rate sniffer configured to monitor the channel and generate feedback affected by the incoming traffic and the generator traffic injected. The controller is configured to control the configurable rate for the SAT, dynamically, based on the feedback generated by the data-rate sniffer and the target rate.

Further alternative HDL design structure embodiments parallel those described above in connection with the example circuit embodiment.

It should be understood that example embodiments disclosed herein can be implemented in the form of a circuit, method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example embodiment of a circuit.

FIG. 2 is a block diagram of another example embodiment of a circuit.

FIG. 3 is a flow diagram of an example embodiment of a method.

FIG. 4 is a block diagram of an example embodiment of a computer environment.

FIG. 5 is a block diagram of an example embodiment of a data center.

### DETAILED DESCRIPTION

A description of example embodiments follows.

The terms frame and frames may be referred to interchangeably herein as packet and packets, respectively, in the context of a generator that generates same, as the generator may be unaware of a type of payload being generated, such as a layer 2 (L2) frame or layer 3 (L3) packet.

It should be understood that a date-rate sniffer as referenced herein may include a plurality of sniffers.

A frame generator that is used for service activation testing (SAT) is typically positioned at an ingress point of a chip, such as after a receive (Rx) media access controller (MAC) and before data-path processing. Such a frame generator may generate several artificial traffic flows, where each flow is typically configured to generate frames by a fixed (static) configurable rate, implemented with a token bucket. A system that incorporates same may be channelized, that is, time-division multiplexing (TDM)-managed, such that each channel incorporates both real Rx traffic, such as network traffic received from a network, and injected traffic from SAT (the former having higher strict priority, in order to prevent SAT from affecting the real traffic). For a given channel, an upstream data-path may take in a full frame (single source) start to end.

An example embodiment disclosed herein may implement a hardware mechanism that monitors the incoming Rx traffic on a channel and configures, dynamically, the SAT frame generator's token bucket accordingly. Such a hardware mechanism may be referred to herein as a SAT generator (SATG). According to an example embodiment, the SAT frame generator may produce traffic that would supplement the actual line rate to a target (desired) rate, and measure performance under generated conditions. The following conditions and terminology may be applied to the present disclosure.

A SAT frame generator may be referred to herein simply as a frame generator. A frame generation rate for the frame generator may be handled by a frame rate controller (FRTC), which may be referred to as a data-rate controller, rate controller, or simply as a controller. Such a controller may be configured to manage a single token bucket per generated flow.

Token Increment: the controller may be configured with values for Tdelta and Tnum parameters per flow. The Tdelta parameter may indicate an amount of clock cycles to count, between each two increments of Tnum tokens into the token-counter. Token increments may be oblivious to TDM, i.e., cycles may be counted continuously. Each token may allow for a single data-word generation (1 clock cycle worth). Another configuration parameter, Tburst, may set an upper limit for the flow's token bucket.

Token Decrement: a data word may be generated only when there is a match between a configured channel identifier (ID), that is, a TDM channel ID of a flow, and an incoming channel ID of a TDM mechanism. When the SAT generator needs to generate a new frame, and the FRTC has enough tokens for the entire frame (i.e., a token counter is bigger than #words in the frame), the FRTC may decrement the token counter by #words in the frame, and generate a new word every time there is a match with the TDM channel ID, until frame completion.

With regard to priority, Rx frames may be given higher (strict) priority versus SAT-generated frames. Such priority may be enforced by a flow control indication from an upstream data-path unit. In order to mitigate SATG's internal pipeline, buffers may be implemented at the SATG output, to temporarily absorb frame words when an upstream unit is busy with Rx data.

In a conventional approach, SATG may have four configurable flows, each with its own configured FRTC and a related parameter set (Tdelta, Tnum, Tburst). SATG may generate the configured traffic rate, but has no indication or relation to an existing, “real,” incoming Rx traffic of the channel. A user may change (e.g., via software) those configurations, but such changes would be blind to the Rx line utilization over time and, obviously, too slow to react to any real-time changes.

An example embodiment disclosed herein may implement a data-rate sniffer that may include a plurality of data-rate sniffers, such as a sniffer on incoming Rx traffic for channel[c], denoted as SI[c]; a sniffer on generated SATG words (generator traffic) for channel[c], denoted as SG[c]; and a sniffer on an overall total TDM rate for a channel[c], denoted as ST[c].

An example embodiment disclosed herein may denote a frequency of the data-rate sniffers' analysis events, i.e., how many clock cycles to count between the data-rate sniffers' analysis events, as Sdelta. A value of Sdelta may be a power of two duplication of Tdelta, so an actual configured value may be denoted as an update_factor=log2(Sdelta/Tdelta). A target data rate for channel[c], denoted as TR[c], may be affected by the Rx real rate and the SATG generated rate. According to an example embodiment, configuration may have two modes.

In a first mode, there may be a total target (desired) rate, i.e., total actual combined rate from both Rx line and SATG (dynamic mode). There may be a reserved value for selecting “full line rate.” In a second mode, there may be an added target (desired) rate, i.e., a target (desired) SATG generated rate (static mode).

According to an example embodiment, hardware logic may be implemented which examines SI[c], SG[c], and ST[c] every Sdelta time, and calculates Snum according to TR, where Snum is the number of tokens that have to be generated by SATG until the next Sdelta event.

After calculating Snum[c], such hardware logic may update the value of Tnum[c] as follows:
Tnum[c] <=(Snum[c]>>update_factor), where Snum[c] may be calculated differently per mode of TR[c]. For example, in a dynamic mode: Snum[c]=TR[c]−SI[c] (If “full line rate” is selected, and then TR[c] replaced with ST[c]), whereas in a static mode: Snum[c]=TR[c].

According to an example embodiment, SATG may provide status indications for both temporary and ongoing average “SATG utilization,” indicating how successful SATG was in opportunistically injecting its designated payload. For a single Sdelta (temporary), this figure is given by:
SG[c][n]/Snum[c][n−1],
   where “n” and “n−1” denote consecutive sniffer analysis events (“n” being the latter one) and measures utilization, namely what was actually injected divided by what was intended for injection, during a specific Sdelta. The accumulated average, calculated upon sniffer analysis event [N], is:
Σ(n=1 . . . n)(SG[c][n])/Σ(n=0 . . . n−1)(Snum[c][n]).
   The hardware logic may provide the nominator and denominator as two separate values to software.

According to an example embodiment, SATG may further provide status indications for both current and ongoing averages of all data-rate sniffer values over time, indicating both current and ongoing average rates of Rx/SATG/TDM. Such status indications may be output to a display screen or an electronic file for non-limiting examples, thereby providing statistics for a user.

To mitigate a combination of Rx traffic having strict priority over SATG traffic, with the fact that frames are consumed from a single source start to finish-two alternative options (approaches) may be considered, A first approach may employ a bigger buffer at SATG output (at least maximum transfer unit (MTU) size), such that local flow-control effects are mediated better, and have a lesser effect on SATG generation rate. A second approach may be to have SATG generate single-word frames only. These options aim to maximize SATG opportunistic traffic injection.

An example embodiment of a hardware mechanism for SAT adds a dynamic real-time ability, which facilitates more accurate and versatile measurements for Service Activation Testing, as depicted in TELECOMMUNICATION STANDARDIZATION SECTOR OF ITU, SERIES Y: GLOBAL INFORMATION INFRASTRUCTURE, INTERNET PROTOCOL ASPECTS AND NEXT-GENERATION NETWORKS, INTERNET OF THINGS AND SMART CITIES, Internet protocol aspects—Quality of service and network performance, Ethernet service activation test methodology, Y.1564 (February 2016) and Bradner et al., “Benchmarking Methodology for Network Interconnect Devices,” RFC 2544, The Internet Society, March 1999:
Stress Testing: Simulate real-world traffic conditions by dynamically adjusting traffic rates, helping to identify potential bottlenecks and performance issues.
Real-Time Adjustments: Adapt to changing network conditions in real-time, providing more accurate and relevant test results.
Proactive Issue Identification: Identify and address potential issues before they impact service, improving overall network reliability and client experience.

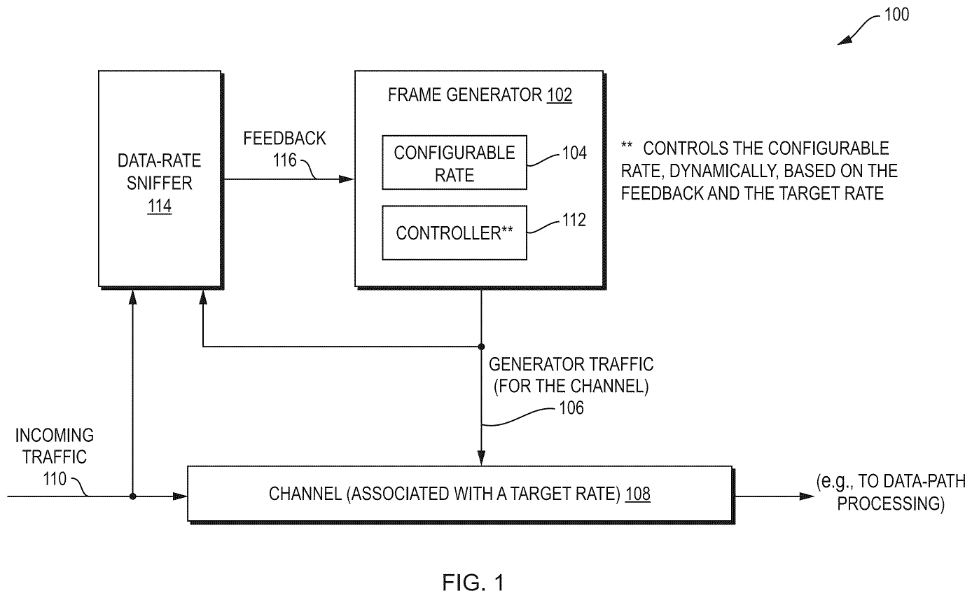

With an example embodiment of SATG dynamic mode, as described, past statistics may be used to derive future behavior. With smaller Sdelta values, a user can increase responsiveness of SATG to local changes (in time). However, using too small Sdelta values might result in unstable behavior, preventing SATG from converging its FRTC parameters, so as to generate the correct frame rate. Overcoming this challenge can be achieved with a step-by-step approach, whereby Sdelta would be incremented gradually until stability is reached (similar to Ramp Load testing). This method would be more efficient with traffic patterns which reach a level of stability over certain time intervals. An example embodiment of a circuit that may employ SATG dynamic mode is disclosed below, with reference to FIG. 1.

FIG. 1 is a block diagram of a circuit 100 that may be used for SAT. The circuit 100 may comprise a frame generator 102 configured to inject, based on a configurable rate 104, generator traffic 106 into a channel 108 for SAT. The channel 108 may incorporate incoming traffic 110 on the channel 108 and the generator traffic 106 that is injected. The channel 108 may be associated with a target rate (not shown). The frame generator 102 may include a controller 112. The circuit 100 may further comprise a data-rate sniffer 114 configured to monitor the channel 108 and generate feedback 116. The feedback 116 generated may be affected by the incoming traffic 110 and the generator traffic 106 injected. The controller 112 may be configured to control the configurable rate 104 for the SAT, dynamically, based on the feedback 116 generated by the data-rate sniffer 114 and the target rate.

It should be understood that the frame generator 102 and data-rate sniffer 114 need not be separate components. For example, the frame generator 102 may include the data-rate sniffer 114.

The controller 112 may be further configured to: control the configurable rate 104 for the SAT, dynamically, by configuring a token bucket (not shown), dynamically, to cause the frame generator 102 to produce the generator traffic 106 to supplement an actual line rate of the incoming traffic 110 to achieve the target rate.

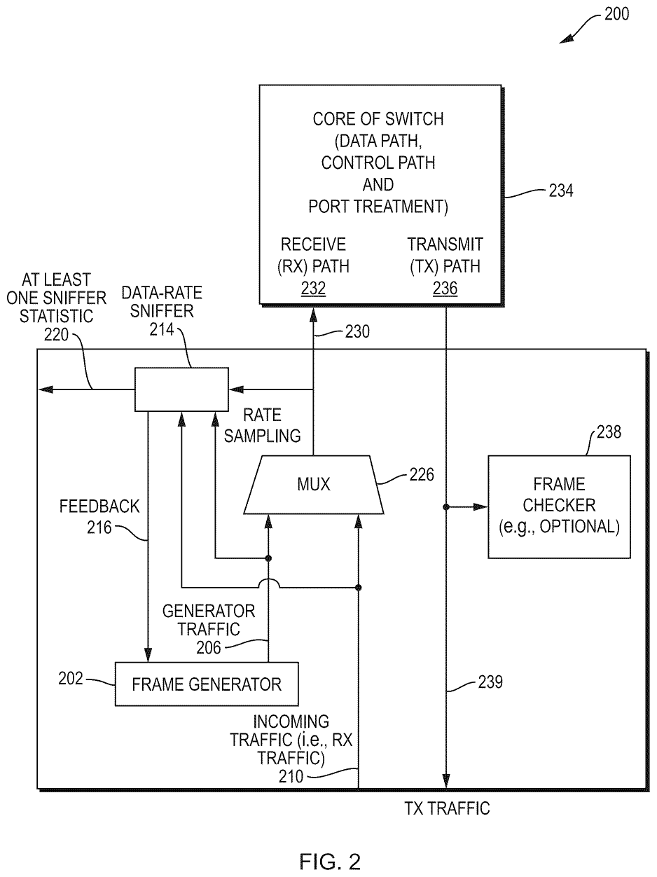

The data-rate sniffers 114 may be further configured to output at least one status indicator (not shown) configured to indicate a result of a comparison between an actual amount of generator traffic 106 injected relative to an intended amount of generator traffic 106 to be injected. The at least one status indicator may be included in the at least one sniffer statistic 220 disclosed further below with reference to FIG. 2.

Continuing with reference to FIG. 1, the channel 108 may be a time-division multiplexing (TDM) channel. The data-rate sniffer 114 may be configured to monitor: a data rate of the incoming traffic 110 on the channel 108, a data rate of the generator traffic 106 injected, and an overall total TDM data rate for the channel 108, such as disclosed further below with reference to FIG. 2.

Continuing with reference to FIG. 1, the data-rate sniffer 114 may be further configured to output status indications for current and ongoing average rates of the data rate of the incoming traffic 110 on the channel, the data rate of the generator traffic 106 injected, and the overall total TDM data rate for the channel 108. Such status indications may be included in the at least one sniffer statistic 220 disclosed below with reference to FIG. 2.

Continuing with reference to FIG. 1, the data-rate sniffer 114 may be further configured to monitor the data rate of the incoming traffic 110 on the channel 108, the data rate of the generator traffic 106 injected, and the overall total TDM data rate for the channel 108 based on a total number of clock cycles to count between sniffer analysis events. A value for the total number may be based on a power of two and a configured value for a token increment of a token counter (not shown) of a token bucket of the frame generator 102.

The incoming traffic 110 on the channel 108 may have strict priority over the generator traffic 106 injected. The circuit 100 may further comprise an output buffer (not shown). The output buffer may have a size of at least an MTU size.

The incoming traffic 110 on the channel 108 may have strict priority over the generator traffic 106 injected and the generator traffic 106 injected may be limited to single-word frames.

The data-rate sniffer 114 may be further configured to generate at least one sniffer statistic for the SAT and output the at least one sniffer statistic generated, such as the at least one sniffer statistic 220 of FIG. 2, disclosed below. The at least one sniffer statistic 220 may represent at least one performance indicator. The performance indicator may represent throughput, latency, jitter, frame loss, or a combination thereof for non-limiting examples.

FIG. 2 is a block diagram of another circuit 200 that may be used for SAT. The circuit 200 may be employed as the circuit 100 of FIG. 1, disclosed above. Continuing with reference to FIG. 1 and FIG. 2, the circuit 200 may comprise a frame generator 202 configured to inject, based on a configurable rate 104, generator traffic 206 into a channel 108 for SAT. The channel 108 may incorporate incoming traffic 210 on the channel 108 and the generator traffic 206 that is injected. The channel 108 may be associated with a target rate (not shown). The frame generator 202 may include a controller 112. The circuit 200 may further comprise a data-rate sniffer 214 configured to monitor the channel 108 and generate feedback 216. The feedback 216 generated may be affected by the incoming traffic 210 and the generator traffic 206 injected. The controller 112 may be configured to control the configurable rate 104 for the SAT, dynamically, based on the feedback 216 generated by the data-rate sniffer 214 and the target rate.

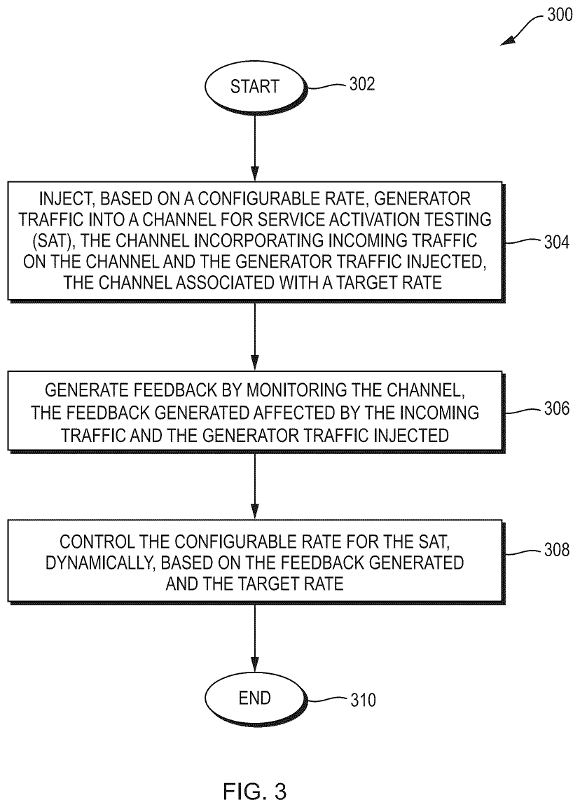

The circuit 200 may further include a multiplexer (mux) 226 to ensure that the incoming traffic 210 on the channel 108 has strict priority over the generator traffic 206 injected. The mux 226 may output traffic 230 to a Rx path 232 of a core of a switch 234 for which the SAT may be implemented. The data-rate sniffer 214 may be further configured to perform rate sampling of the output traffic 230 to produce an overall total TDM data rate for the channel 108. According to an example embodiment, the Rx path 232 may be looped back as transmit (Tx) traffic 239 via a transmit (Tx) path 236, such that the Tx traffic 239 is checked by a frame checker 238 as part of the SAT. The circuit (100, 200) may be used for implementing a method for SAT, such as the method of FIG. 3, disclosed below.

FIG. 3 is a flow diagram 300 of an example embodiment of a method. The method begins (302) and comprises injecting, based on a configurable rate, generator traffic into a channel for SAT (304). The channel incorporates incoming traffic on the channel and the generator traffic injected. The channel is associated with a target rate. The method further comprises generating feedback by monitoring the channel (306). The feedback generated is affected by the incoming traffic and the generator traffic injected. The method further comprises controlling the configurable rate for the SAT, dynamically, based on the feedback generated and the target rate (308). The method thereafter ends (310) in the example embodiment.

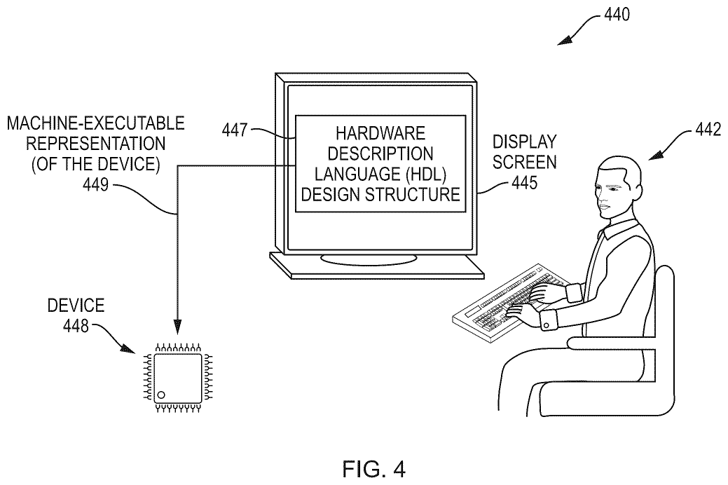

FIG. 4 is a block diagram of an example embodiment of a computer environment 440 in which a user 442 is viewing a display screen 445 of a computer-aided design system 446. The user 442 may use the computer-aided design system 446 to design a hardware description language (HDL) design structure 447. The HDL design structure 447 may be encoded on a machine-readable data storage medium (not shown). The HDL design structure 447 may comprise elements that when processed in the computer-aided design system 446 generate a machine-executable representation 449 of a device 448.

With reference to FIG. 1, FIG. 2, and FIG. 4, the HDL design structure 447 may comprise a frame generator (102, 202) configured to inject, based on a configurable rate 104, generator traffic (106, 206) into a channel 108 for SAT. The channel 108 may incorporate incoming traffic (110, 210) on the channel 108 and the generator traffic (106, 206) injected. The channel 108 may be associated with a target rate. The frame generator (102, 202) may include a controller 112. The HDL design structure 447 may further comprise a data-rate sniffer 114 configured to monitor the channel 108 and generate feedback (116, 216) affected by the incoming traffic (110, 210) and the generator traffic (106, 206) injected. The controller 112 may be configured to control the configurable rate 104 for the SAT, dynamically, based on the feedback (116, 216) generated by the data-rate sniffer (114) and the target rate.

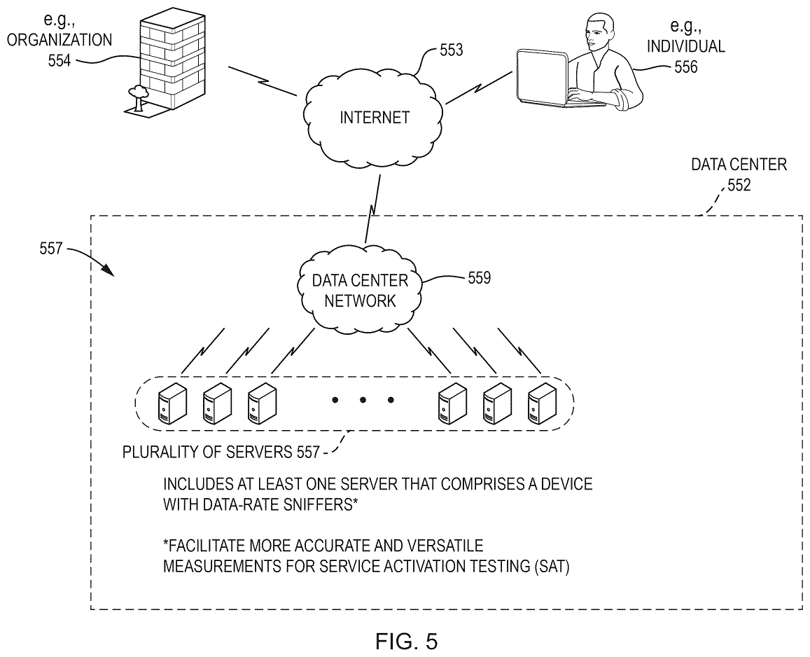

The machine-executable representation 449 of the device 448 may be employed in a server of a data center for non-limiting example, such as the data center disclosed below with regard to FIG. 5 for non-limiting example.

FIG. 5 is a block diagram of an example embodiment of a data center 552. The data center 552 may have consumers that are entities, such as the organization 554, namely a business, and the individual 556 for non-limiting examples. Such consumers may utilize services (not shown) and an infrastructure 557 provided by the data center 552 for storing, processing, and accessing data (not shown) and applications (not shown).

In the data center 552, a plurality of servers 557 may function as core computing resources, responsible for storing, processing, and managing data, applications, and services, forming a backbone of the infrastructure 557. Consumers, such as the organization 554 and individual 556, may utilize such computing resources via the Internet 553 coupled to a data center network 559 of the data center 552 for non-limiting example. The plurality of servers 557 may store and manage vast amounts of data, acting as repositories for information that the consumers may rely on. Servers of the plurality of servers 557 may host various applications, from web servers delivering content, to database servers managing data. Servers of the plurality of servers 557 may provide services, such as email and network management, enabling users to access and utilize resources for non-limiting examples.

Servers of the plurality of servers 557 may provide processing power and memory for running applications and handling data requests. Servers of the plurality of servers 557 may be interconnected within the data center network 559, facilitating communication and data transfer between different systems. Servers of the plurality of servers 557 may be used for data center security, with dedicated servers acting as firewalls, intrusion detection systems, and virtual private network (VPN) gateways for non-limiting examples. Servers of the plurality of servers 557 may be used for backing up data and facilitating disaster recovery. In the data center 552, SAT may be useful for ensuring data integrity for storing, managing, and processing information. In the data center 552, at least one server of the plurality of servers 557 may employ an example embodiment of a device as disclosed below.

According to an example embodiment, a system, such as a server of the plurality of servers 557, may comprise a network interface (not shown) and a device, such as a system on chip (SoC) (not shown) for non-limiting example. Continuing with reference to FIG. 1, FIG. 2, and FIG. 5, the device may be an integrated circuit (IC) for non-limiting example. The device, of the server of at least one server of the plurality of servers 557, may include a frame generator (102, 202) configured to inject, based on a configurable rate 104, generator traffic (106, 206) into a channel 108 for SAT. The channel 108 may incorporate incoming traffic (110, 210) on the channel 108 and the generator traffic (106, 206) injected. The channel 108 may be associated with a target rate. The frame generator (102, 202) may include a controller 112. The HDL design structure 447 may further comprise a data-rate sniffer 114 configured to monitor the channel 108 and generate feedback (116, 216) affected by the incoming traffic (110, 210) and the generator traffic (106, 206) injected. The controller 112 may be configured to control the configurable rate 104 for the SAT, dynamically, based on the feedback (116, 216) generated by the data-rate sniffer (114, 216) and the target rate.

An example embodiment disclosed herein may employ hardware, software, firmware, electronic control component, processing logic, and/or processor device, individually or in any combination, including without limitation: an application specific integrated circuit (ASIC), a field-programmable gate-array (FPGA), an electronic circuit, a processor and memory that executes one or more software or firmware programs, and/or other suitable components that provide the described functionality.

Further example embodiments disclosed herein may be configured using a computer program product; for example, controls may be programmed in software for implementing example embodiments. Further example embodiments may include a non-transitory computer-readable-medium that contains instructions that may be executed by a processor, and, when loaded and executed, cause the processor to complete methods described herein. It should be understood that elements of the block and flow diagrams may be implemented in software or hardware, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read only memory (ROM), compact disk read-only memory (CD-ROM), and so forth. In operation, a general purpose or application-specific processor or processing core loads and executes software in a manner well understood in the art. It should be further understood that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein. Further, example embodiments and elements thereof may be combined in a manner not explicitly disclosed herein.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A circuit comprising:
a frame generator configured to inject, based on a configurable rate, generator traffic into a channel for service activation testing (SAT), the channel incorporating incoming traffic on the channel and the generator traffic injected, the channel associated with a target rate, the frame generator including a controller; and
a data-rate sniffer configured to monitor the channel and generate feedback affected by the incoming traffic and the generator traffic injected, the controller configured to control the configurable rate for the SAT, dynamically, based on the feedback generated by the data-rate sniffer and the target rate.

2. The circuit of claim 1, wherein the controller is further configured to:
control the configurable rate for the SAT, dynamically, by configuring a token bucket, dynamically, to cause the frame generator to produce the generator traffic to supplement an actual line rate of the incoming traffic to achieve the target rate.

3. The circuit of claim 2, wherein the data-rate sniffer is further configured to output at least one status indicator configured to indicate a result of a comparison between an actual amount of generator traffic injected relative to an intended amount of generator traffic to be injected.

4. The circuit of claim 1, wherein the channel is time-division multiplexing (TDM) channel and wherein the data-rate sniffer is further configured to monitor: a data rate of the incoming traffic on the channel, a data rate of the generator traffic injected, and an overall total TDM data rate for the channel.

5. The circuit of claim 4, wherein the data-rate sniffer is further configured to output status indications for current and ongoing average rates of the data rate of the incoming traffic on the channel, the data rate of the generator traffic injected, and the overall total TDM data rate for the channel.

6. The circuit of claim 4, wherein the data-rate sniffer are further configured to monitor the data rate of the incoming traffic on the channel, the data rate of the generator traffic injected, and the overall total TDM data rate for the channel based on a total number of clock cycles to count between sniffer analysis events and wherein a value for the total number is based on a power of two and a configured value for a token increment of a token counter of a token bucket of the frame generator.

7. The circuit of claim 1, wherein the incoming traffic on the channel has strict priority over the generator traffic injected, wherein the circuit further comprises an output buffer, and wherein the output buffer has a size of at least a maximum transmission unit (MTU) size.

8. The circuit of claim 1, wherein the incoming traffic on the channel has strict priority over the generator traffic injected and wherein the generator traffic injected is limited to single-word frames.

9. The circuit of claim 1, wherein the data-rate sniffer are further configured to generate at least one sniffer statistic for the SAT and output the at least one sniffer statistic generated.

10. The circuit of claim 9, wherein the at least one sniffer statistic represents at least one performance indicator and wherein the performance indicator represents throughput, latency, jitter, frame loss, or a combination thereof.

11. A method comprising:
injecting, based on a configurable rate, generator traffic into a channel for service activation testing (SAT), the channel incorporating incoming traffic on the channel and the generator traffic injected, the channel associated with a target rate;
generating feedback by monitoring the channel, the feedback generated affected by the incoming traffic and the generator traffic injected; and
controlling the configurable rate for the SAT, dynamically, based on the feedback generated and the target rate.

12. The method of claim 11, wherein controlling the configurable rate for the SAT, dynamically, includes configuring a token bucket, dynamically, to cause generator traffic injected to supplement an actual line rate of the incoming traffic to achieve the target rate.

13. The method of claim 12, further comprising outputting at least one status indicator configured to indicate a result of a comparison between an actual amount of generator traffic injected relative to an intended amount of generator traffic to be injected.

14. The method of claim 11, wherein the channel is time-division multiplexing (TDM) channel and wherein the method further comprises monitoring: a data rate of the incoming traffic on the channel, a data rate of the generator traffic injected, and an overall total TDM data rate for the channel.

15. The method of claim 14, further comprising outputting status indications for current and ongoing average rates of the data rate of the incoming traffic on the channel, the data rate of the generator traffic injected, and the overall total TDM data rate for the channel.

16. The method of claim 14, further comprising monitoring the data rate of the incoming traffic on the channel, the data rate of the generator traffic injected, and the overall total TDM data rate for the channel based on a total number of clock cycles to count between sniffer analysis events, and wherein a value for the total number is based on a power of two and a configured value for a token increment of a token counter of a token bucket of the frame generator.

17. The method of claim 11, wherein the incoming traffic on the channel has strict priority over the generator traffic injected.

18. The method of claim 17, further comprising limiting the generator traffic injected to single-word frames.

19. The method of claim 11, further comprising generating at least one sniffer statistic for the SAT and outputting the at least one sniffer statistic generated.

20. The method of claim 19, wherein the at least one sniffer statistic represents at least one performance indicator and wherein the performance indicator represents throughput, latency, jitter, frame loss, or a combination thereof.

21. An apparatus comprising:
means for injecting, based on a configurable rate, generator traffic into a channel for service activation testing (SAT), the channel incorporating incoming traffic on the channel and the generator traffic injected, the channel associated with a target rate;
means for generating feedback by monitoring the channel, the feedback generated affected by the incoming traffic and the generator traffic injected; and
means for controlling the configurable rate for the SAT, dynamically, based on the feedback generated and the target rate.

22. A system comprising:
a network interface; and
a device, the device including:
a frame generator configured to inject, based on a configurable rate, generator traffic into a channel for service activation testing (SAT), the channel incorporating incoming traffic on the channel and the generator traffic injected, the channel associated with a target rate, the frame generator including a controller; and
a data-rate sniffer configured to monitor the channel and generate feedback affected by the incoming traffic and the generator traffic injected, the controller configured to control the configurable rate for the SAT, dynamically, based on the feedback generated by the data-rate sniffer and the target rate.

23. The system of claim 22, wherein the system is a server of at least one server of a data center and wherein the device is a system-on-chip (SoC).

24. A hardware description language (HDL) design structure encoded on a machine-readable data storage medium, the HDL design structure comprising elements that when processed in a computer-aided design system generate a machine-executable representation of a device, wherein the HDL design structure comprises:
a frame generator configured to inject, based on a configurable rate, generator traffic into a channel for service activation testing (SAT), the channel incorporating incoming traffic on the channel and the generator traffic injected, the channel associated with a target rate, the frame generator including a controller; and
a data-rate sniffer configured to monitor the channel and generate feedback affected by the incoming traffic and the generator traffic injected, the controller configured to control the configurable rate for the SAT, dynamically, based on the feedback generated by the data-rate sniffer and the target rate.
